(19) United States
(12) Patent Application Publication
(10) Pub. No.: US 2008/0037579 A1
(43) Pub. Date: Feb. 14, 2008

(54) Network adapter

(76) Inventors: Dong-hun Lee, Seoul (KR); Sang-hyuk Kang, Seoul (KR); Jin-sung Park, Seoul (KR); Joon-hyung Park, Seoul (KR); Ji-hwon Kim, Gwangmyung-shi (KR)

Correspondence Address: MCKENNA LONG & ALDRIDGE LLP;Song K. Jung, 1900 K Street, N.W., Washington, DC, 20006, US

(21) Appl. No.: 11/889,318

(22) Filed: Aug. 10, 2007

(30) Foreign Application Priority Data
Aug. 14, 2006 (KR) 10-2006-0076741

(51) Int. Cl. H04L 12/66

(52) U.S. Cl. 370/463

(57) ABSTRACT

The present invention discloses a network adapter which can allow an electric device which does not have a networking function to access various networks and perform a control operation. The network adapter includes a first interface for sending a sound/image signal to one electric device, a second interface for receiving a data from another electric device, a multimedia processing unit for converting the data into a sound/image signal, and a control processing unit for controlling the data received from another electric device to be converted into the sound/image signal and transmitted to one electric device, when the data is required to be converted into the sound/image signal.

### TECHNICAL FIELD

The present invention relates to a network adapter, and more particularly, to a network adapter which can allow an electric device which does not have a networking function to access various networks and perform a control operation.

Background Art

A home network connects various digital home appliances so that the user can always enjoy convenient, safe and economic life services inside or outside the house. A refrigerator and a washing machine called white home appliances have been gradually digitalized with the development of the digital signal processing technology, the home appliance operating system technology and the high speed multimedia communication technology have been intensively applied to the digital home appliances, and new information home appliances have been developed, to improve the home network.

As shown in Table 1, the home network is classified into a data network, an entertainment network and a living network according to types of services.

TABLE 1

| Classification | Function | Service type |
|---|---|---|
| Data network | Network between PC and | Data exchange, Internet |
| | peripheral devices | service, etc. |
| Entertainment | Network between A/V | Music, moving picture |
| network | devices | service, etc. |
| Living network | Network for controlling | Home appliance control, |
| | home appliances | home automation, remote |
| | | meter reading, message |
| | | service, etc. |

The data network is configured between a PC and peripheral devices to exchange data or provide an internet service. The entertainment network is configured between home appliances using audio or video information. The living network is configured to control home appliances, such as home automation or remote meter reading.

A home network system built in a household includes a master device which is an electric device for controlling operations of the other electric devices, or monitoring a status thereof, and a slave device which is an electric device responding to a request of the master device and notifying its status change according to the characteristic of the electric device or other factors. Exemplary electric devices include home appliances for the living network service such as a washing machine and a refrigerator, home appliances for the data network service and the entertainment network service, and products such as a gas valve control apparatus, an automatic door apparatus and an electric lamp.

In the prior art, the electric device must have a module (hardware, software) with a networking function in order to provide the network service to the user. For example, a digital TV requires a network module as well as a digital TV driving module so as to perform the network service. Therefore, the electric device which does not have the networking function cannot perform the network service.

### DISCLOSURE OF THE INVENTION

The present invention is achieved to solve the above problems. An object of the present invention is to provide a network adapter which can allow an electric device which does not have a networking function to perform the networking function.

Another object of the present invention is to provide a network adapter which can provide an image signal and a sound or voice signal through access to an internet and a multimedia apparatus as well as networking to another electric device.

Yet another object of the present invention is to provide a network adapter which can allow the user to select one of various networks and easily perform data communication.

In order to achieve the above-described objects of the invention, there is provided a network adapter, including: a first interface for sending a sound/image signal to one electric device; a second interface for receiving a data from another electric device; a multimedia processing unit for converting the data into a sound/image signal; and a control processing unit for controlling the data received from another electric device to be converted into the sound/image signal and transmitted to one electric device, when the data is required to be converted into the sound/image signal.

In another aspect of the present invention, there is provided a network adapter, including: a first interface for accessing one electric device; a second interface for accessing one or more networks through one or more communication transmission media, respectively; and a control unit for accessing a corresponding network through the second interface according to a network selection command for selecting the network to be connected to the second interface.

### BRIEF DESCRIPTION OF THE DRAWINGS

The present invention will become better understood with reference to the accompanying drawings which are given only by way of illustration and thus are not limitative of the present invention, wherein:

FIG. 1 is a configuration view illustrating a network system using a network adapter in accordance with the present invention; and

FIG. 2 is a configuration view illustrating the network adapter of FIG. 1.

### BEST MODE FOR CARRYING OUT THE INVENTION

A network adapter in accordance with the preferred embodiments of the present invention will now be described in detail with reference to the accompanying drawings.

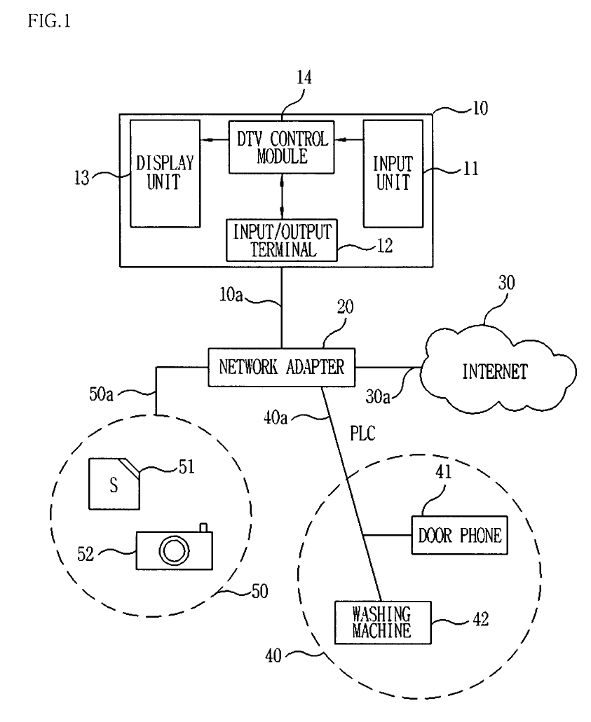

FIG. 1 is a configuration view illustrating a network system using a network adapter in accordance with the present invention. Referring to FIG. 1, basically, a digital TV (DTV) 10 which is an electric device and a network adapter 20 which can be independently operated are connected to each other through a transmission medium 10a to perform communication. In addition, the network adapter 20 is connected to an internet 30 through a transmission medium 30a, a small-sized network 40 through a transmission medium 40a, and an external electric device 50 through a transmission medium 50a.

Fundamentally, the DTV 10, which does not have a networking function to an external electric device, does not include a network interface. The DTV 10 consists of an input unit 11 for allowing the user to input a channel selection and a control command, an input/output terminal 12 connected to the network adapter 20 and another electric device (for example, VCR, etc.), for receiving a sound or voice signal, an image signal and a control signal, and outputting a control signal corresponding to the control command (for example, network selection command, control command for another electric device, etc.) inputted through the input unit 11, a display unit 13 for displaying the voice and image, and a DTV control module 14 for displaying the received voice and image signals on the display unit 13, performing a control operation according to the received control signal, and transmitting a control signal corresponding to the control command from the input unit 11 to the network adapter 20.

The input unit 11 does not only perform an intrinsic function of the TV such as channel selection, but also allows the user to input a control command and select a communication service mode received from the network adapter 20 on a control image displayed on the display unit 13. The input unit 11 can be provided as a remote controller or a keyboard.

The input/output terminal 12 basically has a function of receiving image and voice signals, and additionally has a function of sending and receiving a control signal. The function of sending and receiving the control signal has already been embodied in the general DTV.

The display unit 13 may be a general display means such as an LCD and a PDP.

The DTV control module 14 does not have a function of directly accessing a network and receiving or sending a data. Therefore, the DTV control module 14 receives the image and voice signals from the input/output terminal 12, and displays the image and voice signals on the display unit 13. The image signal indicates all visually displayable data such as character, graph, picture and moving picture.

In addition, the DTV control module 14 can receive a control command (including a selection command) from the user through the input unit 11 with regard to the displayed image and voice signals. For example, when a menu for confirming a state of a door phone 41 in the small-sized network 40 is displayed on the display unit 13, if the user selects the confirmation menu through the input unit 11, the DTV control module 14 generates a control signal corresponding to the confirmation menu, and merely transmits the control signal to the network adapter 20 through the input/output terminal 20. Thereafter, when the network adapter 20 sends image and voice signals associated with the state confirmation through the input/output terminal 12, the DTV control module 14 receives and displays the image and voice signals on the display unit 13. That is, the DTV control module 14 acquires a selection command (network selection command or service selection command) for selecting one of communication service modes (access service to the internet 30, access service to the small-sized network 40, access service to the external electric device 50, etc.) from the input unit 11, and merely transmits the selection command to the network adapter 20 through the input/output terminal 12.

The DTV control module 14 can receive a control data (or signal) for the DTV 10 from the network adapter 20 through the input/output terminal 12, and perform a control operation (for example, channel change, volume up/down, etc.) according to the control signal.

The DTV control module 14 can generate a state data including its current operation state, and send the state data to the network adapter 20 through the input/output terminal 12, as a response to a control signal which is a state confirmation command.

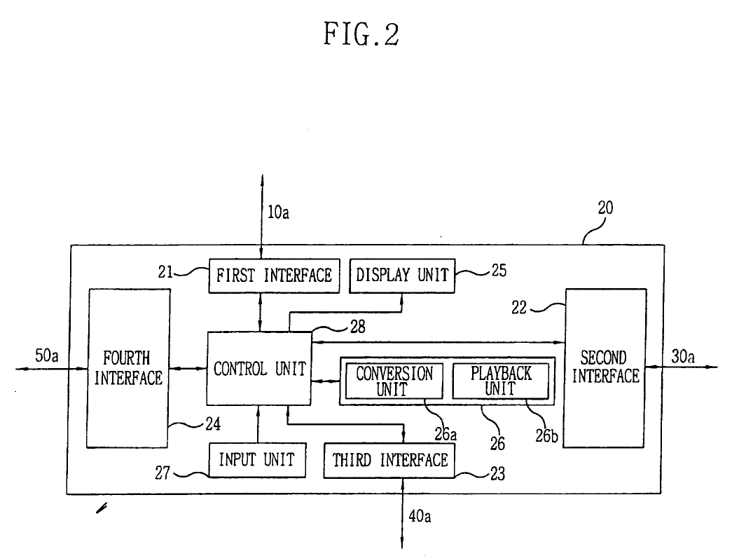

The network adapter 20 performs data transmission/reception between the DTV 10, the internet 30, the small-sized network 40 and the external electric device 50. Detailed explanations thereof will be explained later with reference to FIG. 2.

The internet 30 commonly designates an internet service providing system which enables the network adapter 20 to access a plurality of web pages and receive or send information contents data.

In the small-sized network 40, the door phone 41 and a washing machine 42 are connected through the transmission medium 40a, for example, power line communication (PLC). Between the network adapter 20 and the small-sized network 40, transmission/reception of all data (control signal, state signal, etc.) is performed according to a general method.

The external electric device 50 includes a memory card 51 or a media storage 52 (for example, digital camera, digital camcorder, etc.). The external electric device 50 stores multimedia files such as photograph, music and moving picture. Basically, the external electric device 50 includes an interface for externally transmitting the multimedia files.

FIG. 2 is a configuration view illustrating the network adapter of FIG. 1.

As illustrated in FIG. 2, the network adapter 20 includes a first interface 21 for communicating with the DTV 10 through the transmission medium 10a, a second interface 22 for communicating with the internet 30 through the transmission medium 30a, a third interface 23 for communicating with the small-sized network 40 through the transmission medium 40a, and a fourth interface 24 for communicating with the external electric device 50 through the transmission medium 50a.

The first interface 21 is an access module for sending and receiving the image and voice signals, the control data and the state data through access to the input/output terminal 12 of the DTV 10. A cable for transmitting image and voice data and a data cable can be used as the transmission medium 10a. The first interface 21 is an input/output terminal connected to the transmission medium 10a.

The second interface 22 is a communication module (or modem) for performing data communication pursuant to the TCP/IP communication standard through access to the transmission medium 30a such as an optical cable, telephone line or power line. The second interface 22 can receive the information contents data or the control data from the internet 30, and perform bidirectional communication with the internet 30.

The third interface 23 is a communication module (or modem) for sending and receiving the control signal (data) and the state signal (data) to/from, for example, the small-sized network 40 configured in the premise through the transmission medium 40a (for example, PLC). The third interface 23 may be a PLC modem, ZigBee modem, wireless communication modem or LAN modem.

The fourth interface 24 is an access module for transmitting the multimedia file to the external electric device 50 through the transmission medium 50a such as a USB cable. USB communication or IEEE 1394 can be applied to the fourth interface 24. A reader for reading the memory card 51 may be used as the fourth interface 24.

Preferably, the first interface 21 and the second to fourth interfaces 22 to 24 are physically separated interfaces with totally different transmission media 10a, 30a, 40a and 50a. That is, the first interface 21 and the second to fourth interfaces 22 to 24 must be separated according to different transmission media 10a and 30a and different signal transmission methods.

A display unit 25 may be a display means such as an LCD, or a display means for simply displaying the state of the network adapter 20 (for example, the network connection or selection state, the operation states of the first to fourth interfaces 21 to 24, etc.) through an LED. For example, the display unit 25 can display a state where the network adapter 20 performs communication through the second interface 22 or receives the multimedia file through the fourth interface 24.

A multimedia processing unit 26 includes a conversion unit 26a for converting the data (information contents data, control data, state data (compressed or encoded packet type data, etc.)) received by the network adapter 20 into image and voice signals in order to display the data on the display unit 13 without additional processing in the DTV 10, and a playback unit 26b for playing back the multimedia file as the image and voice signals by using a built-in Codec.

For example, the conversion unit 26a converts the packetized control data and state data received through the third interface 23 into a control image signal, a state image signal and a state voice signal, so that the user can see the data through the display unit 13 like a general user interface or moving picture. That is, the conversion unit 26a converts the data into the image or voice signal to be displayable on the display unit 13.

The playback unit 26b must prestore a file player software and a Codec to play back various types of multimedia files. The playback unit 26b plays back the multimedia files as the image and voice signals by using such means.

An input unit 27 for basically controlling the operation of the network adapter 20 performs on/off state conversion, initialization, etc. The user can select communications by the first to fourth interfaces 21, 22, 23 and 24 through the input unit 27. That is, the user can select one of the second to fourth interfaces 22, 23 and 24 through the input unit 27 to perform data communication with the DTV 10 through the first interface 21. Therefore, the user selects one communication service mode through the input unit 27 from among the access service to the internet 30, the access service to the small-sized network 40, and the access service to the external electric device 50.

A control unit 28 receives data from the second to fourth interfaces 22, 23 and 24. If the received data itself contains an image/voice signal, the control unit 28 can directly transmit the data to the first interface 21 without processing the data by the multimedia processing unit 26. For example, since a signal from a video phone is an image/voice signal, the signal is transmitted directly to the DTV 10 without conversion, and displayed thereon.

In the relation with the DTV 10, the control unit 28 stores a service menu such as access to the internet 30, controlling and monitoring of the small-sized network 40 and playback of the multimedia file by the user using the DTV 10, receives an image or voice signal corresponding to the service menu from the multimedia processing unit 26, and transmits the image or voice signal through the first interface 21. The DTV 10 displays the image and voice of the received service menu through the display unit 13, and sends a control data (or signal) through the input/output terminal 12 according to a selection control command of the user using the input unit 11. The control unit 28 performs a service according to the control signal.

Meanwhile, the control unit 28 selects one of the second to fourth interfaces 22, 23 and 24 according to the communication service mode selection of the user using the input unit 27, and performs data communication between the selected interface and the first interface 21.

In the access to the internet 30, the control unit 28 accesses the internet 30 through the second interface 22, converts a received data into an image or voice signal by the multimedia processing unit 26, and transmits the image or voice signal through the first interface 21. The DTV control module 14 displays the received image or voice signal on the display unit 13 so that the user can be provided with the internet service. Once the internet service is started, the DTV control module 14 receives a control command (for example, shift to a specific web site, etc.) through the input unit 11, and transmits a control signal corresponding to the control command through the input/output terminal 12. The control unit 28 transmits a control pursuant to the received control signal to the internet 30 through the second interface 22, thereby performing a desired control operation of the user. Moreover, the control unit 28 inversely receives the resulting data, converts the data into an image or voice signal, and transmits the image or voice signal to the DTV 10 through the first interface 21.

In the controlling and monitoring of the small-sized network 40, the DTV 10 can control or monitor the electric devices 41 and 42 in the small-sized network 40 through the network adapter 20 as a master device, or the electric devices 41 and 42 in the small-sized network 40 can control or monitor the DTV 10 through the network adapter 20.

In the former, the control unit 28 transmits a state confirmation control signal to the small-sized network 40 through the third interface 23 by selection of the user, and the electric devices 41 and 42 in the small-sized network 40 transmit their state data as responses.

The control unit 28 converts the received state data into an image or voice signal by the multimedia processing unit 26, and transmits the image or voice signal to the DTV 10 through the first interface 21.

The control unit 28 transmits a user interface image controllable by the user with the state data so that the user can perform the control operation. When the user inputs a control command through the input unit 11, the DTV control module 14 generates a control signal corresponding to the control command, and transmits the control signal to the network adapter 20 through the input/output terminal 12. The control unit 28 transmits the received control signal through the third interface 23, to perform the control operation according to the control signal.

In the latter, the control unit 28 receives a state request control signal for the DTV 10 through the third interface 23, and transmits the state request control signal through the first interface 21. The DTV control module 14 transmits its state signal (or state data) through the input/output terminal 12. The control unit 28 sends the received state data to the small-sized network 40 through the third interface 23 so that the state of the DTV 10 can be checked in the electric devices 41 and 42. In order to control the DTV 10, the control unit 28 transmits the control signal received through the third interface 23 to the DTV 10 through the first interface 21.

In the playback of the multimedia file, the control unit 28 receives information (kind of state data or signal) of the current stored files from the external electric device 50 through the fourth interface 24 by selection of the user, converts the information of the files by the multimedia processing unit 26, and sends the resulting information through the first interface 21. The DTV control module 14 displays the received information of the files on the display unit 13 so that the user can select the file to be played back. When the user selects a specific file, the DTV control module 14 generates a corresponding control signal, and transmits the control signal through the input/output terminal 12. The control unit 28 requests transmission of the corresponding file from the external electric device 50 through the fourth interface 24 according to the control signal. The control unit 28 receives the multimedia file from the external electric device 50, plays back the multimedia file as image and voice signals by the multimedia processing unit 26, and transmits the played-back image and voice signals through the first interface 21.

As discussed earlier, even if the electric device such as the DTV 20 does not have the networking function, the network adapter 20 enables the electric device to perform the networking function through transmission/reception of the image and voice signals and the control signal.

In accordance with the present invention, the network adapter can allow the electric device which does not have the networking function to perform the networking function through the built-in input/output means.

In addition, the network adapter can technically satisfy various demands of the user, by providing the image and voice through access to the internet and the multimedia apparatus as well as networking to another electric device.

Furthermore, the network adapter can improve the convenience of the user, by making the user select one of various networks and easily perform the data communication.

Although the preferred embodiments of the present invention have been described, it is understood that the present invention should not be limited to these preferred embodiments but various changes and modifications can be made by one skilled in the art within the spirit and scope of the present invention as hereinafter claimed.

1. A network adapter, comprising:
a first interface for sending a sound/image signal to one electric device;
a second interface for receiving a data from another electric device;
a multimedia processing unit for converting the data into a sound/image signal; and
a control processing unit for controlling the data received from another electric device to be converted into the sound/image signal and transmitted to one electric device, when the data is required to be converted into the sound/image signal.

2. The network adapter of claim 1, wherein, when the received data is not required to be converted, the control processing unit transmits the data to the first interface without conversion.

3. The network adapter of claim 1, wherein the first interface performs transmission/reception of a control data and reception of a state data to/from one electric device, the second interface performs transmission/reception of a control data and a state data to/from another electric device, and the control processing unit performs a control operation according to the received control data.

4. The network adapter of claim 1, wherein the first interface and the second interface are physically separated from each other.

5. The network adapter of claim 1, further comprising a third interface for receiving information contents data through an internet.

6. The network adapter of claim 1, further comprising a fourth interface connected to an external storage device, for receiving a multimedia file.

7. The network adapter of claim 6, wherein the multimedia processing unit comprises a playback unit for playing back the multimedia file as a sound/image signal.

8. The network adapter of claim 1, comprising a display unit for displaying reception of the data.

9. The network adapter of claim 1, comprising an input unit for acquiring a user input for selecting one of the second interface, a third interface and a fourth interface to perform data communication with the first interface.

10. The network adapter of claim 1, wherein the control processing unit receives, from one electric device, a user selection command for selecting one of the second interface, a third interface and a fourth interface to perform data communication with the first interface, and processes the user selection command.

11. A network adapter, comprising:
a first interface for accessing one electric device;
a second interface for accessing one or more networks through one or more communication transmission media, respectively; and
a control unit for accessing a corresponding network through the second interface according to a network selection command for selecting the network to be connected to the second interface.

12. The network adapter of claim 11, wherein the network selection command is received through the first interface.

13. The network adapter of claim 11, comprising an input unit for acquiring the network selection command.

14. The network adapter of claim 11, wherein the network is a network pursuant to a communication standard for internet access, or a network pursuant to a communication standard for a home network.

15. The network adapter of claim 11, comprising a multimedia processing unit for converting a data received through the second interface into a sound/image signal, wherein the control unit sends the sound/image signal to one electric device through the first interface.

16. The network adapter of claim 11, wherein the control unit transmits a control data between one electric device and the selected network through the first and second interfaces.

17. The network adapter of claim 11, further comprising a fourth interface connected to an external storage device, for receiving a multimedia file.

18. The network adapter of claim 17, wherein the control unit receives the multimedia file through the fourth interface according to the network selection command.

19. The network adapter of claim 17, wherein the multimedia processing unit comprises a playback unit for playing back the multimedia file as a sound/image signal.
